(19) United States
(12) Patent Application Publication
(10) Pub. No.: US 2010/0037455 A1
(43) Pub. Date: Feb. 18, 2010

(54) Fuel gas reformer assemblage

(76) Inventor: Roger R. Lesieur, Enfield, CT (US)

Correspondence Address: WILLIAM W. JONES, 6 Juniper Lane, Madison, CT, 06082, US

(21) Appl. No.: 12/586,162

(22) Filed: Sep. 13, 2004

Related U.S. Application Data
(62) Division of application No. 09/814,912, filed on Mar. 23, 2001, now abandoned.

(51) Int. Cl. H01M 8/02

(52) U.S. Cl. 29/623.2

(57) ABSTRACT

A fuel gas-steam reformer assembly, preferably an autothermal reformer assembly, for use in a fuel cell power plant, includes a mixing station for intermixing a relatively high molecular weight fuel and an air-steam stream so as to form a homogeneous fuel-air-steam mixture for admission into a catalyst bed. The catalyst bed includes catalyzed alumina pellets, or a monolith such as a foam or honeycomb body which is preferably formed from a high temperature material such as a steel alloy, or from a ceramic material. The catalyst bed is contained in a shell which is preferably formed from stainless steel or some other high temperature alloy. The shell includes an internal peripheral thermal insulation layer of zirconia (ZrO₂), either in a felt form, or in a rigidified foam. The zirconia insulation layer provides thermal insulation for the shell and retains heat in the catalyst bed and protects the shell against thermal degradation from the hot catalyst bed; and it also protects the catalyst bed against carbon deposition from the fuel and oxygen mixture flowing through the catalyst bed. The use of an internal zirconia insulation layer obviates the need to provide an alumina washcoat and metal oxide coatings on the inner surface of the shell for inhibiting carbon deposition in the catalyst bed. The zirconia insulation layer is non-acidic and possesses carbon gasification properties which are similar to the carbon gasification properties possessed by calcium and alkali metal oxides. Unlike silica insulation, zirconia insulation does not vaporize in the presence of high temperature steam.

### TECHNICAL FIELD

This invention relates to a fuel gas steam reformer assemblage for reforming hydrocarbon fuels such as gasoline, diesel fuel, methane, methanol or ethanol, and converting them to a hydrogen-rich fuel stream suitable for use in powering a fuel cell power plant. More particularly, this invention relates to a reformer assemblage which employs a zirconia (ZrO₂) insulation lining for a shell structure which houses the catalyst bed in the reformer assemblage.

### BACKGROUND OF THE INVENTION

Fuel cell power plants include fuel gas steam reformers which are operable to catalytically convert a fuel gas, such as natural gas or heavier hydrocarbons, into the primary constituents of hydrogen and carbon dioxide. The conversion involves passing a mixture of the fuel gas and steam, and, in certain applications air/oxygen and steam, through a catalytic bed which is heated to a reforming temperature that varies, depending upon the fuel being reformed. Typical catalysts used would be a nickel or noble metal catalyst which is deposited on alumina pellets. Of the three types of reformers most commonly used for providing a hydrogen-rich gas stream to fuel cell power plants, tubular thermal steam reformers, autothermal reformers, and catalyzed wall reformers, the autothermal reformer has a need for rapid mixing capabilities in order to thoroughly mix the fuel-steam and air prior to entrance into the reformer catalyst bed.

U.S. Pat. No. 4,451,578, granted May 29, 1984 contains a discussion of autothermal reforming assemblages, and is incorporated herein in its entirety. The autothermal reformer assembly described in the '578 patent utilizes catalyzed alumina pellets. In the design of auto-thermal reformers for hydrogen-fueled fuel cell systems, there is a need for rapid and thorough mixing of the reactants (air, steam and fuel) prior to entry of the reactants into the catalyst bed. The autothermal reformers require a mixture of steam, fuel and air in order to operate properly. These reformers are desirable for use in mobile applications, such as in vehicles which are powered by electricity generated by a fuel cell power plant. The reason for this is that autothermal reformers can be compact, simple in design, and are better suited for operation with a fuel such as gasoline or diesel fuel. One requirement for a fuel processing system that is suitable for use in mobile applications is that the system should be as compact as possible, thus, the mixing of the steam, fuel and air constituents should be accomplished in as as compact an envelope as possible. The catalyst bed assembly is typically provided with a jacket of insulation disposed on the outside of the catalyst bed housing. It is also desirable to include materials such as certain metal oxides in the catalyst bed and on the reactor walls which serve to inhibit carbon deposition in the catalyst bed. The carbon-inhibiting metal oxides will be coated onto the catalyst support, be it alumina pellets or a ceramic or metal foam monolith as well as the reactor walls. It would be desirable to be able to protect the entire reactor against carbon deposition. Reformers of the type described above will have an inlet temperature in the range of about 900° F. to about 1,100° F. and an outlet temperature in the range of about 1,200° F. to about 1,300° F. The maximum operating temperature in the reformer would be about 1,750° F. Care must be taken to ensure that the carbon deposition inhibitor used in the reformer will be able to effectively operate in the aforesaid temperature range, and be stable.

### DISCLOSURE OF THE INVENTION

This invention relates to a fuel gas reformer assemblage which is operable to reform fuels such as gasoline, diesel oil or other suitable fuel so as to convert the fuel into a hydrogen-enriched fuel gas which is suitable for use as the fuel stock for a fuel cell power plant, and which is provided with a thermal insulation material that suppresses carbon deposition in the reformer assemblage and catalyst bed. The reformer assembly in question can be a compact autothermal reformer which is suitable for use in mobile applications such as for producing electricity for powering an electric or partially electric vehicle, such as an automobile. In an autothermal reformer assemblage formed in accordance with this invention, air, steam and fuel are mixed in a premixing section prior to entering the autothermal reformer section of the assemblage. The reformer section includes a fuel, steam and air mixing station and the reforming catalyst bed. The catalyst bed can be a two stage bed, the first stage being, for example, an iron oxide catalyst stage, and the second stage being, for example, a nickel catalyst stage. The second stage could contain other catalysts, such as noble metal catalysts including rhodium, platinum, palladium, or a mixture of these catalysts. Alternatively, the catalyst bed could be a single stage bed with a noble metal catalyst, preferably rhodium, or a mixed rhodium/platinum catalyst.

The catalyst bed is contained in a housing which is preferably cylindrical or oval and includes an upper wall through which reactant mixing tubes extend. The inside surfaces of the side and upper walls of the catalyst bed housing are thermally insulated with a zirconia lining which can take the form of a zirconia felt or a rigidified zirconia. We have discovered that the zirconia insulation is capable of inhibiting carbon deposition on the reactor walls. By placing the zirconia insulation inside of the catalyst bed housing, the walls of the catalyst bed housing are protected against heat-induced degredation up to temperatures of about 3,000° F. and also are protected against carbon deposition from the gases being reformed. Typical silica/alumina insulations, on the other hand, not only promote carbon formation, but the silica tends to vaporize from the insulation in a steam atmosphere of over 1,200° F. and then condense at lower temperatures, thus poisoning the catalyst and fouling downstream heat exchangers.

It is therefore an object of this invention to provide an air/steam/fuel reformer assembly which includes a catalyst bed disposed in an internally thermally insulated housing.

It is a further object of this invention to provide an assembly of the character described wherein the thermal insulation for the catalyst bed is operative to inhibit carbon deposition in the catalyst bed.

It is yet another object of this invention to provide an assembly of the character described wherein the thermal insulation is zirconia.

These and other objects and advantages of the invention will be more readily understood from the following detailed description of a specific embodiment of the invention when taken in conjunction with the accompanying drawing, in which:

### BRIEF DESCRIPTION OF THE DRAWINGS

FIG. 1 is fragmented cross sectional view of a fuel gas assembly formed in accordance with this invention.

### DETAILED DESCRIPTION OF THE INVENTION

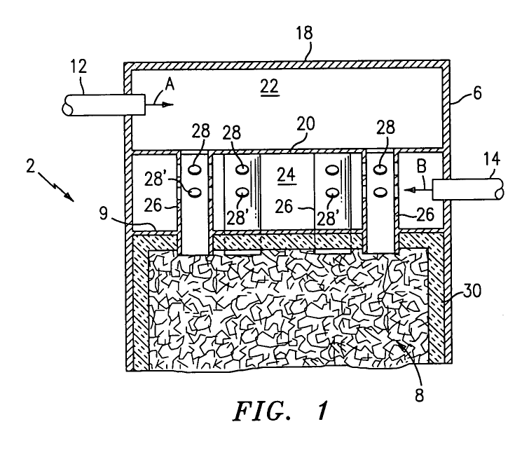

Referring now to FIG. 1, one embodiment of a reformer assembly formed in accordance with this invention is designated by the numeral 2 and can be cylindrical, oval or some other curvilinear cross sectional shape. A reforming catalyst bed 8 is disposed in a shell 6 below a lower transverse wall 9. A tube 12 carries a vaporized fuel reactant, and a tube 14 carries an oxidant/steam reactant, which oxidant is usually air. The vaporized fuel may also include some steam which assists in vaporizing the fuel. If so desired, the contents of the tubes 12 and 14 could be reversed. A top wall 18 closes the upper end of the shell 6, and an intermediate wall 20 divides the upper end of the shell 6 into an upper manifold 22 and a lower manifold 24. The lower manifold 24 is separated from the catalyst bed 8 by the wall 9. The tube 12 opens into the upper manifold 22 and the tube 14 opens into the lower manifold 24. Thus the vaporized fuel is fed into the upper manifold 22, and the air/steam mixture is fed into the lower manifold 24. A plurality of mixing tubes 26 extend between the upper manifold 22 to the catalyst bed 8 through the wall 9. The mixing tubes 26 interconnect the fuel manifold 22 with the catalyst bed 8. The mixing tubes 26 include two sets of openings 28 and 28′ which open into the air manifold 24. The assemby 2 operates generally as follows. The vaporized fuel mixture enters the manifold 22 per arrow A and flows out of the manifold 22 to the catalyst bed 8 through the mixing tubes 26. Air and steam enter the manifold 24 per arrow B and enter the mixing tubes 26 through the openings 28 and 28′. As the mixture flows through the catalyst bed 8 it encounters the inner zirconia insulation 30 which both protects the outer shell 6 from heat and inhibits carbon deposition in the catalyst bed 8. There are two chemical reactions that take place in the reformer assembly which contribute to the inhibition of carbon in the catalyst bed. They are:

ZrO₂+XC→ZrO_{2-X}+XCO; and

C+2H₂O→CO₂+2H₂.

The zirconia insulation can take the form of a soft felt or it can be rigidified. The insulation performs three functions in the reformer: a) it thermally insulates the walls of the catalyst bed, holding heat in the bed and protecting the outer shell against heat; b) it inhibits carbon deposition on the walls of the catalyst bed; and c) when a thicker insulation layer is required, a rigidified zirconia insulation can be used to seal the monolith against the reactor walls thereby preventing reactant bypass. While the reformer assembly has been described in connection with the reforming of a fuel such as gasoline or diesel fuel, it will be appreciated that other fuels such as natural gas can also be reformed in the assembly of this invention. The ability of the zirconia insulation to inhibit carbon deposition is the result of the fact that it is non-acidic, and it serves as an oxygen donor to carbon atoms which are formed in the reactor.

Since many changes and variations of the disclosed embodiment of the invention may be made without departing from the inventive concept, it is not intended to limit the invention otherwise than as required by the appended claims.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. A method for minimizing carbon deposition on walls of a high temperature catalytic steam reformer assembly catalyst bed, which is operable operative to convert a fuel into a hydrogen-enriched fuel gas stream, said method comprising the step of covering internal surfaces of said reformer assembly catalyst bed walls with a carbon deposition-inhibiting thermal insulating material that will not vaporize at reformer assembly catalyst bed operating temperatures of up to about 1,750° F.

16. The method of claim 15 wherein said thermal insulating material is a non-acidic oxygen donor.

17. The method of claim 15 further comprising the step of providing a monolithic catalyst bed encased within said reformer assembly walls, and utilizing said insulating material as a gas seal for edges of said monolithic reformer catalyst bed.

18. The method of claim 15 wherein said insulating material is zirconia (ZrO₂).
